(19) United States
(12) Patent Application Publication
(10) Pub. No.: US 2006/0006263 A1
(43) Pub. Date: Jan. 12, 2006

(54) Revolving-screw assembly for a food grinder

(76) Inventor: Jui-Lin Chen, Wu Feng Hsiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/886,306

(22) Filed: Jul. 7, 2004

(51) Int. Cl. B02C 19/22

(52) U.S. Cl. 241/260.1

(57) ABSTRACT

A revolving-screw assembly for a food grinder includes a grinder housing, a feed tube and a cutting screw. The grinder housing has a discharge end and a food chamber defined through the discharge end. The food chamber has a fluted interior surface and an axis. The feed tube that is radially offset from the axis of the food chamber is formed on the grinding housing communicates with the food chamber and has an axis. The cutting screw is rotatably and coaxially mounted in the food chamber and cooperates with the fluted interior surface of the food chamber to grind and transport food inserted though the feed tube. Consequently, the food is easy to be pushed into the food chamber via the feed tube because the rotations of the cutting screw will draw the food into the food chamber.

### BACKGROUND OF THE INVENTION

1. Field of the Invention

The present invention relates to a revolving-screw assembly for a food grinder, and more particularly to a revolving-screw assembly having a grinding housing with a rotating cutting screw and a feed tube radially offset from the cutting screw formed on the grinding housing to efficiently supply food into the grinding housing via the feed tube.

2. Description of Related Art

With reference to FIGS. 5 and 6, a conventional revolving-screw assembly (50) in accordance with the prior art for a food grinder comprises a grinder housing (51), a feed tube (52), a cutting screw (53) and a cover (54).

The grinding housing (51) is cylindrical and has a food chamber (511), a discharge end (512) and an exterior thread (513). The food chamber (511) is defined through the discharge end (512) and has a fluted interior surface (514) and an axis (515). The exterior thread (513) is defined at the discharge end (512) of the grinding housing (51) onto which the cover (54) is screwed.

With further reference to FIG. 7, the feed tube (52) is formed on the grinding housing (51), communicates with the food chamber (511) and has an axis (521). A person can insert food such as meat or vegetables into the food chamber (511) through the feed tube (52). The axis (521) of the feed tube (52) is aligned with the axis (515) of the food chamber (511).

The cutting screw (53) is rotatably and coaxially mounted in the food chamber (511) and cooperates with the fluted interior surface (514) of the food chamber (511) to grind and transport the food inserted though the feed tube (52) when the cutting screw (53) is rotated.

The cover (54) screws onto the exterior thread (513) on the grinding housing (51) and has a central through hole (541). The central through hole (541) is aligned with the food chamber (511) to allow the ground food transported by the cutting screw (53) to discharge out of the food chamber (511).

However, since the axis (521) of the feed tube (52) is aligned with the axis (515) of the food chamber (511), the feed tube (52) is not tangentially arranged about the cutting screw (53). The person needs to use a pusher (not shown) to push and force the food in the feed tube (52) into the food chamber (511) because the rotations of the cutting screw (53) do not provide sufficient drawing force along a tangent of the cutting screw (53) to draw in the food.

Consequently, the conventional revolving-screw assembly (50) is inconvenient to use when using the pusher to force the food in the feed tube (52) inside the food chamber (511).

To overcome the shortcomings, the present invention provides a revolving-screw assembly that has an offset feed tube relative to a cutting screw of the revolving-screw assembly to mitigate or obviate the aforementioned problems.

### SUMMARY OF THE INVENTION

The main objective of the invention is to provide a revolving-screw assembly that has a feed tube and a grinding housing, and the feed tube is radially offset from the grinding housing to permit supply of food into the grinding housing through the feed tube.

A revolving-screw assembly includes a grinder housing, a feed tube and a cutting screw. The grinder housing has a discharge end and a food chamber defined through the discharge end. The food chamber has a fluted interior surface and an axis. The feed tube that is radially offset from the axis of the food chamber is formed on the grinding housing, communicates with the food chamber and has an axis. The cutting screw is rotatably and coaxially mounted in the food chamber and cooperates with the fluted interior surface of the food chamber to grind and transport food inserted though the feed tube. Consequently, the food is easy to be pushed into the food chamber via the feed tube because the rotations of the cutting screw will draw the food into the food chamber.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a revolving-screw assembly in accordance with the present invention;

FIG. 2 is a front elevational view of a grinding housing and a feed tube of the revolving-screw assembly in FIG. 1;

FIG. 3 is a side elevational view in partial section of the revolving-screw assembly in FIG. 1;

FIG. 4 is a top plan view of the revolving-screw assembly in FIG. 1;

FIG. 5 is a perspective view of a conventional revolving-screw assembly in accordance with the prior art;

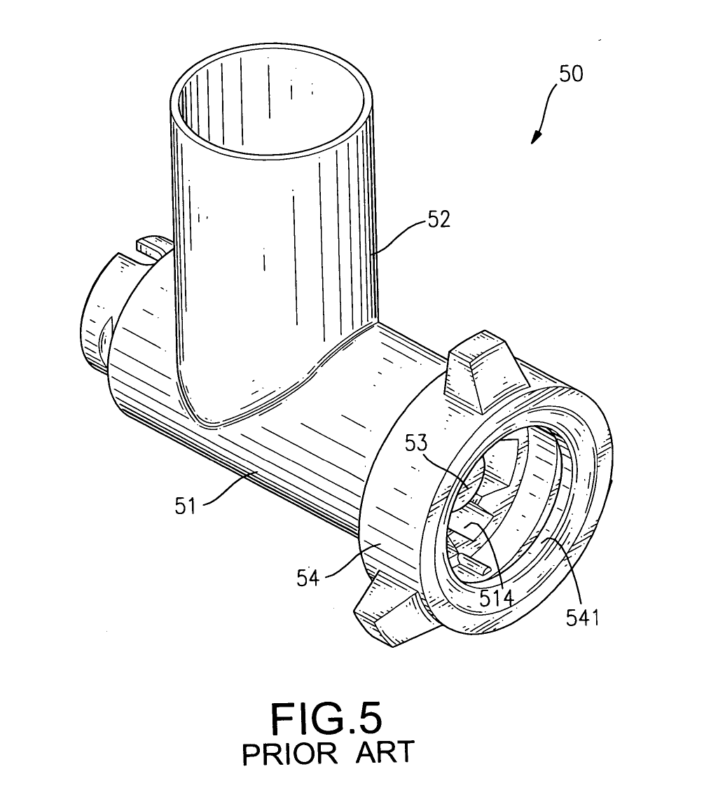

FIG. 6 is top plan view of the conventional revolving-screw assembly in FIG. 5; and

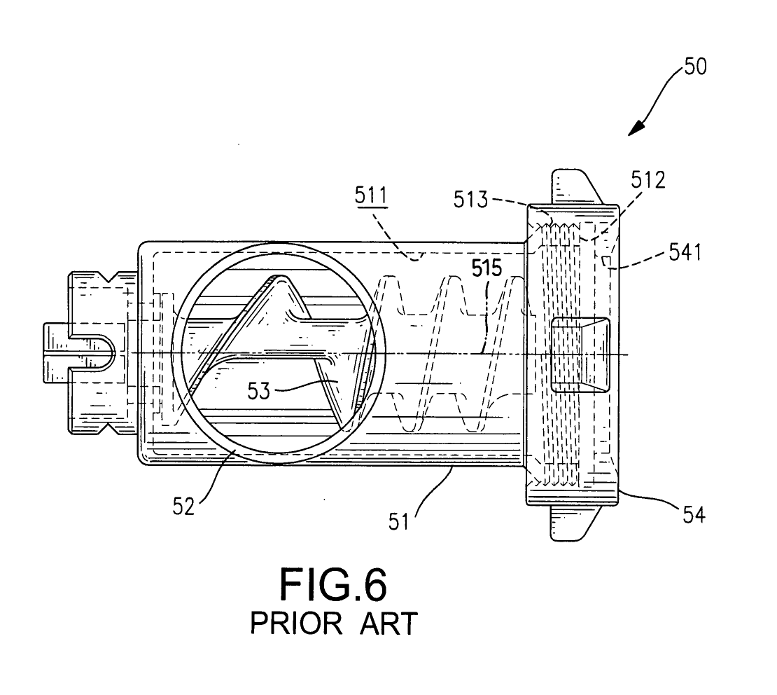

FIG. 7 is a front elevational view of a grinding housing and a feed tube of the conventional revolving-screw assembly in FIG. 5.

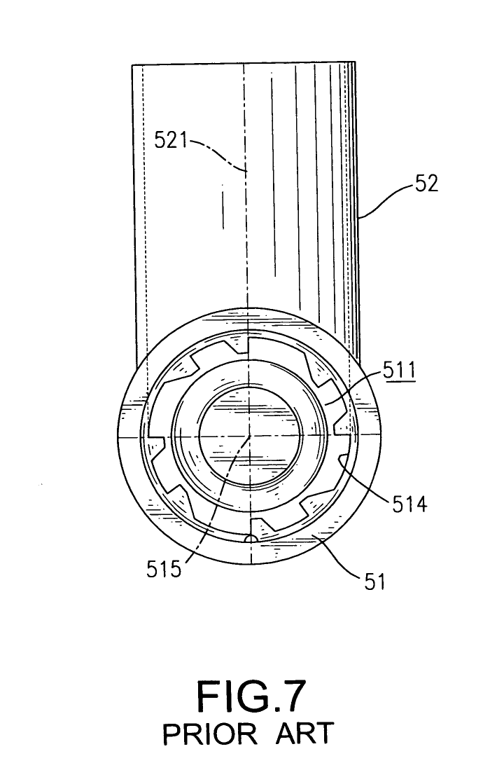

### DETAILED DESCRIPTION OF PREFERRED EMBODIMENT

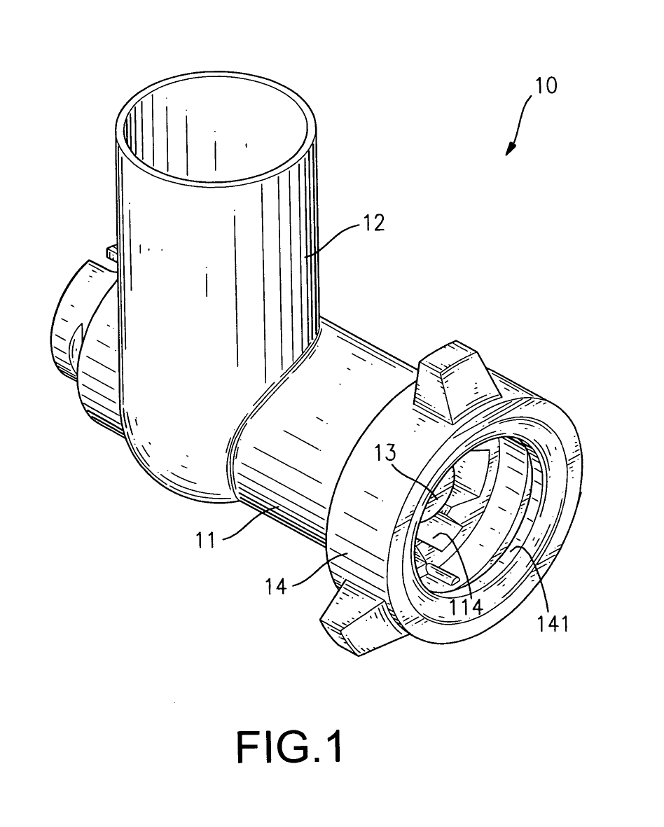

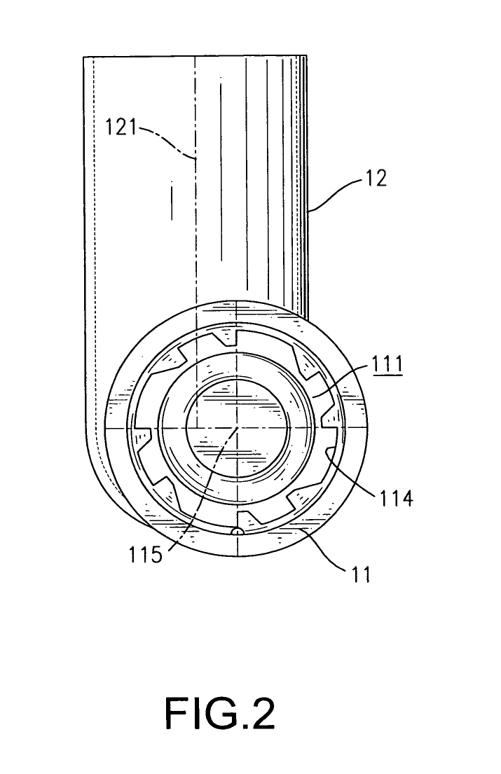

With reference to FIGS. 1 and 2, a revolving-screw assembly (10) in accordance with the present invention for a food grinder comprises a grinder housing (11), an offset feed tube (12), a cutting screw (13) and a cover (14).

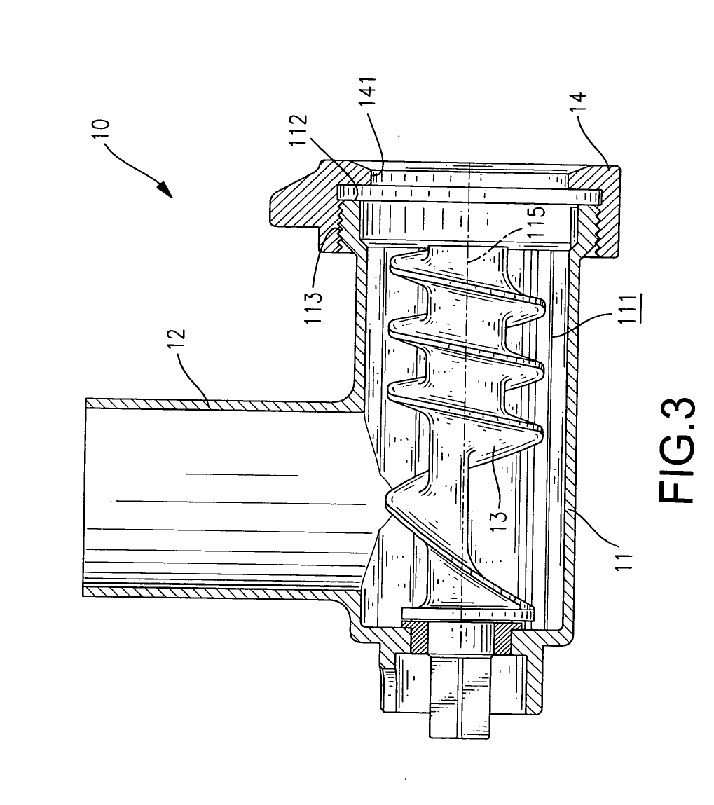

With further reference to FIG. 3, the grinding housing (11) is cylindrical and has a food chamber (111), a discharge end (112) and an exterior thread (113). The food chamber (111) is defined through the discharge end (112) and has a fluted interior surface (114) and an axis (115). The exterior thread (113) is defined at the discharge end (112) of the grinding housing (11) onto which the cover (14) is screwed.

The feed tube (12) is radially offset from the axis (115) of the food chamber (111) and is a cylinder. The cylindrical feed tube (12) is formed on the grinding housing (11), communicates with the food chamber (111) and has an axis (121). A person can insert food such as meat or vegetables into the food chamber (111) through the feed tube (12). The axis (121) of the feed tube (12) is positioned with a distance apart from the axis (115) of the food chamber (111).

The cutting screw (13) is rotatably and coaxially mounted in the food chamber (111) and cooperates with the fluted interior surface (114) of the food chamber (111) to grind and transport the food inserted though the feed tube (12).

The cover (14) screws onto the exterior thread (113) on the grinding housing (11) and has a central through hole (141). The central through hole (141) is aligned with the food chamber (111) to allow the ground food transported by the cutting screw (13) to discharge out of the food chamber (111).

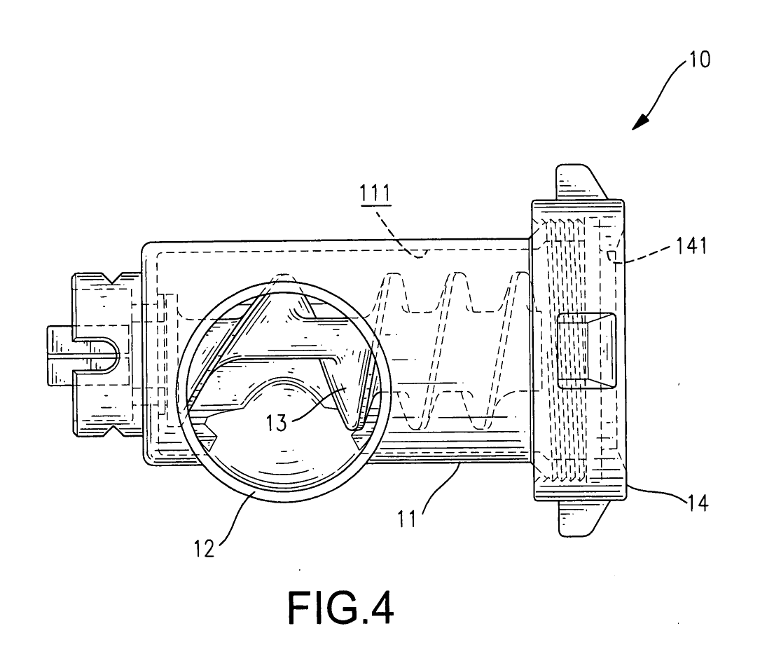

With reference to FIGS. 3 and 4, as the feed tube (12) is tangentially positioned about the cutting screw (13), the rotations of the cutting screw (13) will draw the food in the feed tube (12) into the food chamber (111), whereby the cutting screw (13) cooperating with the fluted interior surface (14) will grind the food. The ground food in the food chamber (111) will be simultaneously transported by the rotating cutting screw (13) and is discharged through the central through hole (141) of the cover (14).

Consequently, the food in the feed tube (12) is easier to be pushed into the food chamber (111) than using a conventional revolving-screw assembly. Using a food grinder with a revolving-screw assembly in accordance with the present invention is convenient and quick to produce ground food.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

What is claimed is:

1. A revolving-screw assembly for a food grinder, and the revolving-screw assembly comprising
a grinder housing having a discharge end and a food chamber defined through the discharge end, and the food chamber having a fluted interior surface and an axis;
a feed tube with an axis radially offset from the axis of the food chamber, formed on the grinding housing and communicated with the food chamber; and
a cutting screw rotatably and coaxially mounted in the food chamber and cooperating with the fluted interior surface of the food chamber to grind and transport food inserted though the feed tube.

2. The revolving-screw assembly as claimed in claim 1, further comprising a cover mounted at the discharge end of the grinding housing;
wherein, the grinding housing further has an exterior thread defined at the discharge end of the grinding housing, and the cover screws onto the exterior thread on the grinding housing and has a central through hole aligned with the food chamber to allow the ground food transported by the cutting screw to discharge out of the food chamber.

3. The revolving-screw assembly as claimed in claim 1, wherein the feed tube is a cylinder.
